(19) United States
(12) Patent Application Publication
(10) Pub. No.: US 2023/0121822 A1
(43) Pub. Date: Apr. 20, 2023

(54) WIRED HEADSETS

(71) Applicant: HEWLETT-PACKARD DEVELOPMENT COMPANY, L.P., Spring, TX (US)

(72) Inventors: Hsiao-Jou Lin, Spring, TX (US); Alexander Williams, Spring, TX (US); Jon R. Dory, Ft. Collins, CO (US)

(73) Assignee: HEWLETT-PACKARD DEVELOPMENT COMPANY, L.P., Spring, TX (US)

(21) Appl. No.: 17/914,481

(22) PCT Filed: Apr. 29, 2020
(86) PCT No.: PCT/US2020/030432

§ 371 Date: Sep. 26, 2022

(51) Int. Cl. H04R 1/10

(52) U.S. Cl. CPC H04R 1/1033; H04R 1/1066; H04R 1/1008

(57) ABSTRACT

Structures and functions of wired headsets are disclosed. In an example, a wired headset includes a first earcup and a second earcup. A headband and a wire to connect with the first earcup. The first earcup connected to the wire is capable of rotation to facilitate routing of the headset wire from the first earcup to the second earcup along with the headband. The headset also includes latches and holders to hold the wire when it routes from the first earcup to the second earcup.

### BACKGROUND

A headset may be used as a part of communication system. The headset facilitates communication among users through desktops, laptops or mobiles in hands-free mode. It also provides an option for the user to listen to audio without disturbing other users in the vicinity.

### BRIEF DESCRIPTION OF THE DRAWINGS

Some examples of the present application are described with respect to the following figures:

FIG. 1 illustrates a headset, according to an example.

FIG. 2 illustrates a diagram of a headset, according to an example.

FIG. 3 illustrates a diagram of a headset, according to an example.

FIGS. 4A, 4B, 4C illustrate rotation of an earcup, according to an example;

FIG. 5 illustrates a flow chart of the method for headset wire management, according to an example.

### DETAILED DESCRIPTION

In general, the headset includes a pair of audio output devices, such as speakers, to convert the electrical signals received from the systems, such as laptops, desktops, phones, audio players, radio, or other entertainment devices to audio signals. Some headsets include wire, connected with one of the audio output devices, to carry the electrical signal from the system to the audio output devices. The headset is designed in a way that the audio output devices can conveniently place on or over auricles of the user. For convenient use of the headset, the wire of the headset should hassle-free route from the audio output device to the headset.

Electronic devices like laptop computers, notebook computers, tablets, phones, audio players, radio, or other entertainment devices have built-in speakers or external speakers or both for audio output. The devices include ports to connect portable audio output devices like headsets. The users have a choice to listen to the audio from the built-in speakers or use headsets as audio output devices. Examples described herein reduced hassle wired headset usable with an electronic device.

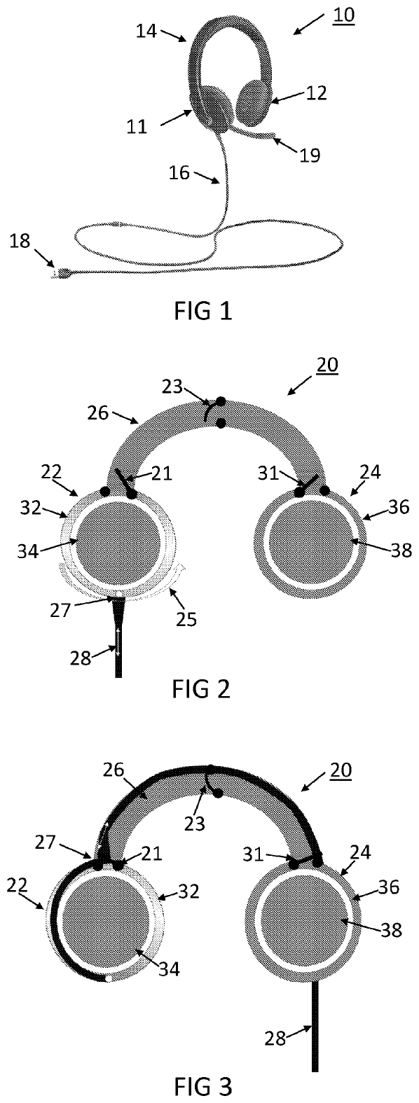

Referring to FIG. 1, a headset 10 generally includes two earcups 11, 12, connected through a headband 14. The headset 10 of FIG. 1 includes a wire 16 connectable to an audio producing device through a connector 18. The connector 18, illustrated in FIG. 1, is a universal serial bus (USB) connector. In another example, the connector 18 of the headset 10 is an audio connector, as known in the state of the art. In yet another example, the connector 18 of the wired headset 10 may be an audio 3.5 mm headphone jack.

The headset 10 works or becomes active when the connector 18 connects with a USB port of an electronic device. In an example, the headset 10 could connect to an audio output port, 3.5 mm port or any other appropriate output port of an electronic device depending on the type and model of the connector 18. The electronic device produces electrical signals corresponding to audio data, such as for any live or pre-recorded audio and transfers the electrical signals at the output port where the connector 18 of the headset 10 is connected.

The earcup 11 of the headset 10 receives electrical signals through a circuit board located inside the earcup 11, from an electronic device through the connector 18 and the wire 16, as illustrated in FIG. 1. The earcup 11 is also referred to as a wired earcup as it is connected to the wire 16 of the headset 10. The circuit board of the earcup 11 converts the electrical signals received from the electronic device in audio signals. The audio signals converted from the electrical signals by the circuit board of the earcup 11, produces an output sound at the earcups 11 12, placed on or over auricles of the user. In another example, the headset 10 is a wired bone conduction headset and the earcups 11, 12 of the headset 10 can conduct the sound in the user's ear through the user's skull bones.

The wire 16 is connected with the earcup 11 of the headset 10, as illustrated in FIG. 1. The wire 16 may be integrally attached to the circuitry within the earcup 11 or may be detachably connected to the earcup 11, such as via an audio port on the earcup 11 where the wire 16 includes an end with an appropriate audio jack connector. While using the headset 10, it may convenient for a user to connect the headset 10 to an electronic device which has an audio output port at the same side of the user as the earcup 11. If the audio output port of the electronic device and the earcup 11 of the headset 10 are at the same side i.e. either the left side or the right side, of the user then the user may connect the wire 16 of the headset 11 to the audio output device directly i.e. without any strain to the wire 16. In case the earcup 11 and the audio output port of the electronic device are at the opposite side of the user, then to avoid the strain on the wire 16, the user may route the wire 16 through the headband 14 to the earcup 12. To route the wire 16 from the earcup 11 to the earcup 12, a user rotates the earcup 11 by 180 degrees and route the wire 16 to the earcup 12 through the headband 14. In an example the headband 14 is made of plastic or rubber or poly vinyl chloride (PVC) or artificial leather or a combination thereof. The headband 14 may be over-the-head or behind-the-ears. The rotation axis of the earcup 11 is an imaginary line perpendicular to a center point of the earcup 11. The rotation of the earcup 11 and the wire 16 route from the earcup 11 to earcup 12 is explained hereafter.

The headset 10 may include a microphone 19, as shown in FIG. 1. The microphone 19 is used as an audio input device and is an accessory connected to the headset 10. A user may send audio signals to the electronic device through microphone 19. The microphone 19 captures the sound produced by the user and converts the sound to the electrical signals. The electrical signals then transmit from the headphone 10 to the electronic device through wire 16 and the connector 18. In another example, the microphone 19 is a detachable accessory and can be attached or removed with the headset 10 by a user.

FIG. 2 illustrates a perspective view of a headset 20. The headset 20 has two earcups 22, 24 connected through a headband 26. The headset 20 also has two latches 21, 31 connected with the two earcups 22, 24 and a holder 23 attached to the headband 26, as illustrated in FIG. 2. The latches 21, 31 attached at the surfaces of the earcups 22, 24 are to latch a wire 28 with the surface of the earcups 22, 24. The holder 23, attached at the surface of the headband 26 is to hold the wire with the surface of the headband 26. The wire 28 connected to the earcup 22 of the headset 20 receives electrical signals from an electronic device. The wire 28 has a connector, not shown in FIG. 2, to connect the headset 20 with the electronic device to receive electrical signals from the audio output port of the electronic device. A transducer, which is a part of the circuit board of the earcup 22 of the headset 20, receives the electrical signals from the electronic device through the wire 28 and converts the electrical signals to audio signals to produce sound, associated with the received electrical signals, from the earcups 22, 24 of headset 20. The earcup 32 is connected to the wire 28 at a joint 27 of headset 20 and the wire 28 carries electrical signals from the electronic device to the earcup 32, as illustrated in FIG. 2.

When the headset 20, as shown in FIG. 2, is placed on or over the auricles of the user, if the audio output port of the computing device is at the same side of the user as the earcup 22 of the headset 20 then the wire 28 of the headset 20 experience less strain. When the audio output port of the electronic device and the earcup 22 of the headset 20 are at the same side of the user then the user connects the wire 28 of the headset 20 to the audio output device with no strain to the wire 28.

The wired earcup 22 has an outer part 32 and an inner part 34, as shown in FIG. 2. The outer part 32 is a section of the wired earcup 22 which is capable of rotation and the inner part 34 another section of the wired earcup 22, other than the outer part 32 which encloses the circuit board of the earcup 22. In an example, the inner part 34 of the wired earcup 22 and an inner part 38 of the earcup 24 are touching the auricles of the user. The outer part 32 of the earcup 22 is connected to the wire 28 and is capable of rotation of 180 degrees at its axis i.e. 180 degrees circular motion 25 as shown in FIG. 2. In an example, the outer part 32 of the earcup 22 is capable to rotate at any degree from 0 to 360 degrees. The outer part 32 may freely rotate with respect to the inner part 34 or may be guided within a range of rotation, such as in a lock step fashion. The outer part 32 may rotate while circuit board and/or other components coupled to the inner part 34 stay fixed with respect to their orientation in the earcup 22.

In a situation when a user puts on the headset 20 in a way the earcup 22 is on an opposite side of the audio output port of the electronic device, with respect to the user, then the wire 28 passes in front of the user to connect the wire 28 to the audio output port, which may strain the wire 28 and cause discomfort to the user. The earcup 22 of the headset 20 is on the opposite side of the audio output port of the electronic device, with respect to the user. In other words, either the earcup 22 is on the left auricle of the user and the audio output port of the electronic device is at the right side of the user or the earcup 22 is on the right auricle of the user and the audio output port of the electronic device is at the left side of the user. In an example, the earcup 22 has an outer part 32 which is capable of rotation of 180 degrees at its axis i.e. 180 degrees circular and an immovable inner part 38. The axis of rotation is an imaginary line perpendicular to a center point of the outer part 32 of the earcup 22 that would extend towards a user's auricle and away from the user's auricle when worn. In this manner, the rotational movement may be parallel with respect to the user's ears, for example. In some examples, the inner part 34 is coupled to padding that is to be placed against or around the ears of a user, thus when the outer part 32 rotates, the earcup 22 maintains contact with the user and without a portion of the earcup rotating against the user's skin, for example.

To avoid the strain to the wire 28 and discomfort to the user, the user may route the wire 28, connected to the earcup 22 of the headset 20, shown in FIG. 2, through the headband 26 to the earcup 24. To route the wire 28 from the earcup 22 to the earcup 24, a user rotates the outer part 32 of the earcup 22 by 180 degrees circularly in the direction 25, as illustrated in FIG. 2. The latch 21 holds the outer part 32 of the wired earcup 22 after 180 degrees rotation along with the wire 28 at a joint 27 where the wire 28 is connected to the outer part 32 of the earcup 22, as shown in FIG. 3. The wire 28 routes from the earcup 22 to the earcup 24 along with the headband 26 and is fixed with the headset 20 structure. The holder 23 at the headband 26 holds the wire 28 with the headband 26. In another example, the holder 23 is same type, material and model as latches 21, 31. In yet another example, the holder 23 is a loop of plastic or other flexible material with a hook to lock the wire 28 with the headband 26. At the earcup 24, the latch 31 holds the wire 28 at the earcup 24, as shown in FIG. 3. In another example, the latches 21, 31 have fixed and moveable parts wherein the movable part mechanically connects with the fixed part to hold the wire 28 with the earcups 22, 24.

FIG. 3 illustrates the wire 28 of the headset 20 routes from the earcup 22 to earcup 24 along with the headband 26 and is fixed to the headset 20 structure with the help of the latches 21, 31 available at earcups 22, 24 and the holder 23 fixed to the headband 26 of the headset 20. In an example, the headband 26 and the earcup 24 defines a groove with a clip to hold the wire 28 wherein the groove may be defined on an external surface of the headband 26. For example, the contour of the headband may include a ridge that is approximately the same diameter of the wire, such that the wire may reside within the groove. In another example, the latch 21 is either completely or partly in contact with the headband 26. In yet another example, the headband 26 has more than one holder 23. Further according to an example, the outer part 36 or the inner part 38 of the earcup 24 are capable to rotate to an angle between 0 to 360 degrees for hassle free management of the wire 28. In some examples, both the outer part 36 and the inner part 38 of the earcup 24 are capable of rotation in a range between 0 to 360 degrees.

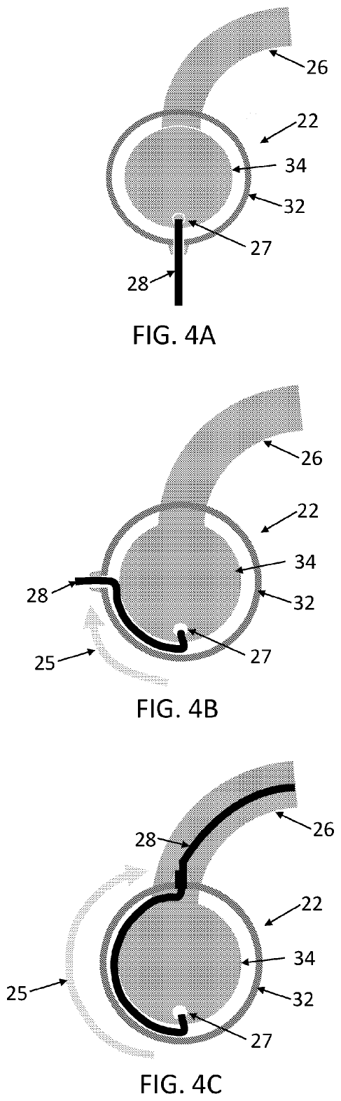

FIGS. 4A, 4B, and 4C illustrate rotation of the wired earcup 22 and the headband 26 of the headset 20, shown in FIG. 2 and FIG. 3. FIG. 4A illustrates the outer part 32 of the earcup 22 is at 0 degree and the wire 28 connected with the inner part 34 of the earcup 22 through joint 27 free falls downwards from the earcup 22. The wire 28 connects with the circuit board of the inner part 34 through the joint 27.

FIG. 4B illustrates the rotation of the outer part 32 of the earcup 22 by 90 degrees. Due to the rotation of the earcup 22 by 90 degrees the wire 28 connected with the inner part 34 of the earcup 22 exiting the outer part 32 of the earcup 22 at 90 degrees with respect to the position of the outer part 32 shown in FIG. 4A. The wire 28 is pulled into a channel between the inner part 34 of the earcup 22 and the outer part 32 of the earcup 22 as the outer part 34 rotates about the center of the earcup 22 between the orientation shown in FIG. 4A and 4B, Thus, after the rotation of the earcup 22 by 90 degrees, the wire 28 exists from the outer part 32, as shown in FIG. 4B, by guiding an amount of wire relative to the amount of rotation into the channel and, thereby, keeping the electrical connection of the wire 28 with the circuit board of the earcup 22 physically and electrically intact through the joint 27.

FIG. 4C illustrates the earcup 22 and the headband 26 with 180 degrees rotation of the outer part 32 of the earcup 22. Due to the 180 degrees rotation, the wire 28 routes from the joint 27 towards the headband 26 within the outer part 32 of the earcup 22. The wire 28 continues to route through the channel between the inner part 34 of the earcup 22 and the outer part 32 of the earcup 22 as the outer part 34 continues to rotate between the 90 degrees position of FIG. 4B and the 180 degrees position of FIG. 4C. Thus, the wire 28 routes from the circuit board of the earcup 22 to the headband 26 through a channel between the outer part 32 and inner part 34 of the earcup 22 such that the wire 28 now exits the channel out of the outer part 32 at a position 180 degrees from the orientation shown in FIG. A. In this manner, the length of the wire 28 from the earcup 22 to the connector end of the wire 28 appears to reduce by the amount of rotation of the outer part 34 of the earcup 22 (e.g., the amount equal to the length of the channel in which that portion of the wire is now hidden from view of the user). As described further herein, the length of the wire 28 available from the headset 22 to the connector end may reduce by the amount utilized to hide the wire 28 within the earcup 22 upon rotation and guide the wire 28 along the headband 26 and towards the earcup 24. FIG. 4C illustrates, the routing of the wire 28, connected at the joint 27 with the circuit board of the inner part 34 of the earcup 22, from the joint 27 to the headband 26 by rotating the outer part 32 of the earcup 22 with 180 degrees.

In an example, the rotation of the ear cup 22 may be mechanically assisted. The mechanically assisted rotation of the ear cup 22 includes a mechanical arrangement of gears, bearings and lock mechanism. In another example, the rotation of the earcup 22 may be a motorized system. The motorized system for the rotation of the earcup 22 is operable by a push button for automatic rotation.

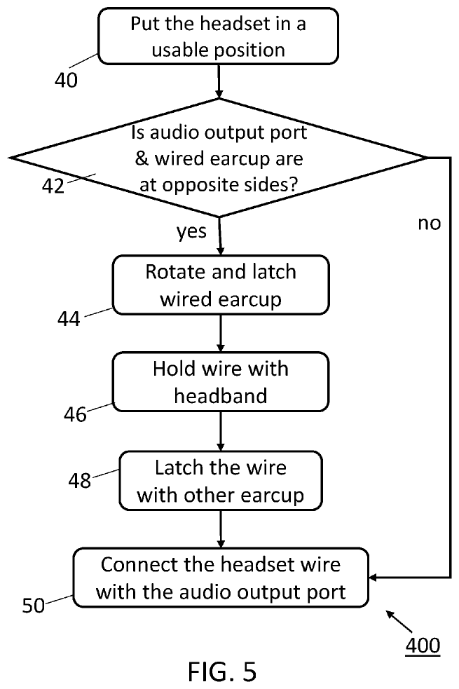

In some examples, functionalities described herein in relation to any of figures may be provided in combination with functionalities described herein in relation to any of FIG. 5.

FIG. 5 illustrates a flow chart of the method for the management of a wire of a headset, according to the example. The method 400 of operation generally includes the headset placed by the user on the auricles and see if the audio output port of an electronic device is at the same side of the user as a wired earcup of the headset. If the audio output port and the wired earcup are on the same side of the user, then the user can directly connect the wire with the audio output port of the device and start using the headset. Else if the audio output port and the wired earcup are not at the same side of the user i.e. the audio output port is at the right side of the user and the wired earcup is at the left side of the user or vice versa then the wire is routed through a headband of the headset to earcup by rotating an outer part of the wired earcup and holding the wire by the holder at the headband of the headset. The method 400 may be implemented by the arrangement of a headset shown in FIG. 2 and FIG. 3.

At block 40 of the flow chart, a user puts the headset 20 in a usable position. The usable position is to place the earcups 22, 24 of headset 20 on the auricles of the user.

At block 42 of the flow chart, user checks whether the audio output port of the electronic device and the wired earcup 22 of the headset 20 are at opposite sides of the user i.e. the earcup 22 is on the left auricle of the user and the audio output port of the electronic device is at the right side of the user or the earcup 22 is on the right auricle of the user and the audio output port of the electronic device is at the left side of the user. If the audio output port of the electronic device and the wired earcup 22 of the headset 20 are not on opposite sides i.e. on the same side of user then the user connects the wire 28 of the headset 20 with the audio output port of the electronic device as mention at block 50 of the flow chart and start using the headset 20.

If the audio output port of the electronic device and the wired earcup 22 of the headset 20 are on opposite sides of the user then, at block 44 of the flow chart, the user rotates the outer part 32 of the earcup 22 in direction 25, shown in FIG. 2, and hold it after 180-degree rotation by the latch 21. In an example, the outer part 32 of the wired earcup 22 is capable of circular rotation from 0 to 360 degrees. Due to the rotation the outer part 32 of the wired earcup 22, the joint 27 i.e. the point where the wire 28 and the outer part 32 of the wired earcup 22 are connected, is held by the latch 21, as shown in FIG. 3.

At block 46 of the flow chart, the wire 28 of the headset 20 routed along with the headband 26 and the holder 23 holds the wire 28 with the headband 26, as shown in FIG. 3. In an example, the headband 26 has more than one holder to hold the wire 28 with the headband 26 of the headset 20. In another example, a groove is defined over the surface of the headband 26 between the wired earcup 22 and the earcup 24 to hold the wire 28 along with the headband 26. In some examples, the holder may be integrated into the headband 26 and in other examples, the holder may be a separate mechanical piece such as detachable sleeve that uses VELCRO to reattach to the headband 26 to keep the wire 28 in place.

At block 48 of the flow chart, the wire 28 latches by the latch 31 at the earcup 24 to route the wire 28 from one side of the user to another side of the user i.e. from the wired earcup 22 to the earcup 24. In an example, a groove is defined on the surface of the earcup 24 to hold the wire 28. In another example, the wire 28 routed along with the headband 26 free falls over the earcup 24 to complete the routing of the wire 28. In yet another example, the outer part 36 of the earcup 24 is capable of circular motion. In yet another example, the headset 20 includes a push button, electrically or mechanically connected to the earcup 22, aids the rotation of the wired earcup 22.

At block 50 of the flow chart, the connector of the wire 28 of the headset 20 connects with the audio output port of the electronic device. In an example, the connector of the wire 28 is a USB type connector. In another example, the headset 20 connects to an audio output port, 3.5 mm port or any other output port of the electronic device based on the type and model of the connector of the wire 28. In this manner, the user may be able to rotate the earcup and guide the wire through the holders and/or latches to move the wire from one side of the headset 20 to the other side of the headset 20 without taking off the headphones or disconnecting from the audio output port of the electronic device and disrupting the user's audio experience, for example.

Although the flow diagram of FIG. 5 illustrates specific orders of execution, the execution order may differ from that which is illustrated. For example, the execution order of the blocks may be scrambled relative to the order shown. Also, the blocks shown in succession may be executed concurrently or with partial concurrence. All such variations are within the scope of the present description.

All the features disclosed in this specification (including any accompanying claims, abstract and drawings), and/or all the elements of any method or process so disclosed, may be combined in any combination, except combinations where at least some of such features and/or elements are mutually exclusive.

The terms “include,” “have,” and variations thereof, as used herein, mean the same as the term “comprise” or an appropriate variation thereof. Furthermore, the term “based on,” as used herein, means “based at least in part on.” Thus, a feature described as based on some stimulus may be based on the stimulus or a combination of stimuli including the stimulus. The article “a” as used herein does not limit the element to a single element and may represent multiples of that element. Furthermore, use of the words “first,” “second,” or related terms in the claims are not used to limit the claim elements to an order or location, but are merely used to distinguish separate claim elements.

The present description has been shown and described with reference to the foregoing examples. It is understood that other forms, details, and examples may be made without departing from the spirit and scope of the following claims.

What is claimed is:

1. A wired headset, comprising:
a first earcup wherein the first earcup is capable of a rotation;
a latch to hold the first earcup at a position;
a headband to connect the first earcup with a second earcup; and
a holder at the headband to hold a wire.

2. The wired headset of claim 1, wherein the wire is connected to the first earcup.

3. The wired headset of claim 1, wherein the first earcup has an outer part and an inner part.

4. The wired headset of claim 2, wherein the wire routes between the outer part and the inner part of the first earcup to the headband.

5. The wired headset of claim 1, wherein the latch is in connection with the headband.

6. The wired headset of claim 1, further comprising a second holder at the second earcup to hold the wire.

7. The wired headset of claim 1, wherein a surface of the second earcup defines a groove to hold the wire.

8. The wired headset of claim 1, wherein the second earcup is capable of a rotation.

9. A wired headset, comprising:
a first earcup wherein the first earcup is capable of a rotation;
a latch to hold the first earcup at a position;
a headband to connect the first earcup with a second earcup; and
a groove at a surface of the headband to hold a wire.

10. The wired headset of claim 9, wherein the wire is connected to the first earcup.

11. The wired headset of claim 9, wherein the latch is in connection with the headband.

12. The wired headset of claim 9, further comprising a holder at the second earcup to hold the wire.

13. The wired headset of claim 9, further comprising a second groove at the second earcup to hold the wire.

14. The wired headset of claim 9, wherein the groove at the headband further comprising a clip to hold the wire.

15. The wired headset of claim 9, wherein the second earcup is capable of a rotation.
